(19) United States
(12) Patent Application Publication
(10) Pub. No.: US 2024/0398171 A1
(43) Pub. Date: Dec. 5, 2024

(54) Burger Press for Transportation

(71) Applicant: Liqiong Pan, Gaozhou City (CN)

(72) Inventor: Liqiong Pan, Gaozhou City (CN)

(21) Appl. No.: 18/204,958

(22) Filed: Jun. 2, 2023

(51) Int. Cl. A47J 43/18; A47J 43/20

(52) U.S. Cl. CPC A47J 43/18; A47J 43/20

(57) ABSTRACT

A burger press includes a pressing plate and a handle frame, wherein the handle frame is configured for being detachably mounted to the pressing plate or is pivotally mounted to the pressing plate, so that the handle frame and the pressing plate are detached from each other or folded with each for transportation.

### BACKGROUND OF THE PRESENT INVENTION

### Field of Invention

The present invention relates to a meat processing tool, and more particularly to a burger press that is easy for transportation.

### Description of Related Arts

A burger press is generally used to press and smash a meat to form a flat burger patty for the professional burger look. Referring to FIG. 1 of the drawings, a conventional smash burger press comprises a smashing plate 1, a mounting frame 2, and a handle 3, the mounting frame 2 comprises a bottom plate 201 and two mounting arms 202 for mounting two ends of the handle 3, the bottom plate 201 is fixed to the smashing plXate 1 by one or more rivets 203. When the user is cooking in a pan, on a grill or over a campfire, the user may hold on the handle 3 to drive the smashing plate 1 to grill meat, press a paninis or make a flat and crispy bacon.

Referring to FIG. 2 of the drawings, another conventional smash burger press comprises a smashing plate 1, a mounting frame 2, and a handle 3, the mounting frame 2 comprises two mounting arms 202 which are integrally extended from the smashing plate 1 for mounting the two ends of the handle 3. In other words, the mounting frame 2 and the smashing plate 1 of this conventional smash burger press are integrally forged.

Referring to FIG. 3 of the drawings, a third conventional smash burger press comprises a smashing plate 1, a vertical handle 3 connected to the smashing plate 1, and a round base 4 defining a smashing chamber 401 for receiving the meat, the smashing plate 1 can be fitted into the smashing chamber 401 to press the meat in the smashing chamber 401.

As shown in the above drawings, the conventional smash burger press generally comprises the vertical mounting frame 2 or the vertical handle 3 which is permanently fixed or integrally extended from the smashing plate 1, so that a height along the vertical direction is relatively large and each conventional smash burger press is required to be placed into a packing box for transportation. In other words, the packing pox is not able to packaging a large number of the conventional smash burger presses, so that it is always a problem for the burger press manufacturers to transport the burger presses from the factory to the warehouse or the retail store, and for the burger presses distributors to ship the burger presses from the warehouse or the retail store to the end user.

### SUMMARY OF THE PRESENT INVENTION

An advantage of the present invention is to provide a burger press comprising detachable components or foldable components to enable a compact size during storing, so that it is easy for transportation.

Another advantage of the present invention is to provide a burger press which is convenient for transportation, so that the cost of the storing and transportation of the burger press is reduced.

Another advantage of the present invention is to provide a burger press which comprises a pressing plate and a handle frame which is detachably mounted to the pressing plate, so that the pressing plate and the handle frame can be detached from each other for transporting the burger press, and the risk of damage to the burger press during transportation is also reduced.

Another advantage of the present invention is to provide a burger press which comprises a pressing plate and a handle frame which is detachably mounted to the pressing plate, wherein during transportation, a large number of the pressing plates can be overlappedly stored in a packaging box while a large lumber of the handle frames can be overlappedly stored in another packaging box, so that it is convenient for the burger press manufacturers to transport the burger presses from the factory to the warehouse or the retail store.

Another advantage of the present invention is to provide a burger press which comprises a pressing plate and a handle frame which is pivotally mounted to the pressing plate, so that the handle frame is folded and stacked on the pressing plate, so as to reduce an occupying room during storing and transportation of the burger press.

Another advantage of the present invention is to provide a burger press which enables a user to easy to assemble the burger press before using the burger press.

Another advantage of the present invention is to provide a burger press which is provided with a plurality of pressing plates with different smashing patterns, so that the user is able to form desired pattern by selecting a desired pressing plate from the plurality of pressing plates.

Another advantage of the present invention is to provide a burger press which is easy to manufacture and the cost is low.

Additional advantages and features of the invention will become apparent from the description which follows, and may be realized by means of the instrumentalities and combinations particularly pointing out in the appended claims.

According to the present invention, the foregoing and other objects and advantages are attained by a burger press, comprising a pressing plate and a handle frame, wherein the handle frame is configured for being detachably mounted to the pressing plate, wherein the handle frame and the pressing plate are detached from each other for transportation.

The present invention further provided a burger press comprising a pressing plate and a handle frame, wherein the handle frame is movably mounted to the pressing plate and is moved between a folded state in which the handle frame is folded and stacked on the pressing plate for transportation and an unfolded state in which the handle frame is unfolded for a user to operate.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a first conventional smash burger press.

FIG. 2 is a perspective view of a second conventional smash burger press.

FIG. 3 is a perspective view of a third conventional smash burger press.

FIG. 4 is a perspective view of a burger press according to a first preferred embodiment of the present invention.

FIG. 5 is an exploded view of the burger press according to the above first preferred embodiment of the present invention.

FIG. 6 is a perspective view illustrating a smashing pattern of the burger press according to the above first preferred embodiment of the present invention.

FIG. 7 is a perspective view illustrating the burger press being used to press and smash a meat according to the above first preferred embodiment of the present invention.

FIG. 8 is a perspective view of a burger press according to a first alternative mode of the above first preferred embodiment of the present invention.

FIG. 9 is a perspective view of a burger press according to a second alternative mode of the above first preferred embodiment of the present invention.

FIG. 10 is a perspective view of a burger press according to a second preferred embodiment of the present invention.

FIG. 11 is an exploded view of the burger press according to the above second preferred embodiment of the present invention.

FIG. 12 is a perspective view of a burger press according to a first alternative mode of the above second preferred embodiment of the present invention.

FIG. 13 is a perspective view of a pressing plate of a burger press according to a second alternative mode of the above second preferred embodiment of the present invention.

FIG. 14 is a perspective view of another pressing plate of the burger press according to the above second alternative mode of the above second preferred embodiment of the present invention.

FIG. 15 is a perspective view of a burger press according to a third preferred embodiment of the present invention.

FIG. 16 is an exploded view of the burger press according to the above third preferred embodiment of the present invention.

FIG. 17 is a perspective view of a burger press in an unfolded state according to a fourth preferred embodiment of the present invention.

FIG. 18 is an exploded view of the burger press in a folded state according to the above fourth preferred embodiment of the present invention.

FIG. 19 is a perspective view of a burger press in an unfolded state according to a fifth preferred embodiment of the present invention.

FIG. 20 is an exploded view of the burger press in a folded state according to the above fifth preferred embodiment of the present invention.

FIG. 21 is a partial enlarged view of an area A of FIG. 19.

FIG. 22 is a perspective view of a burger press in an unfolded state according to a sixth preferred embodiment of the present invention.

FIG. 23 is a perspective view of the burger press in a folded state according to the above sixth preferred embodiment of the present invention

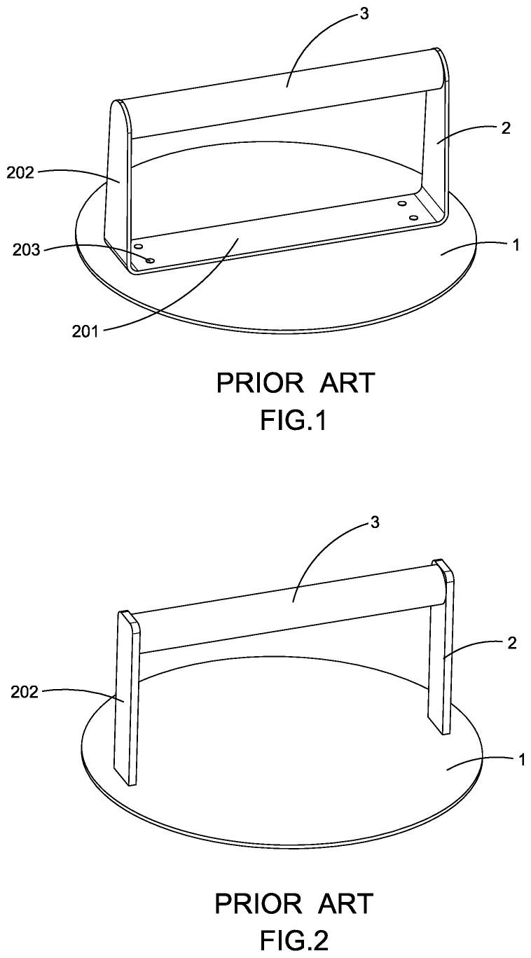

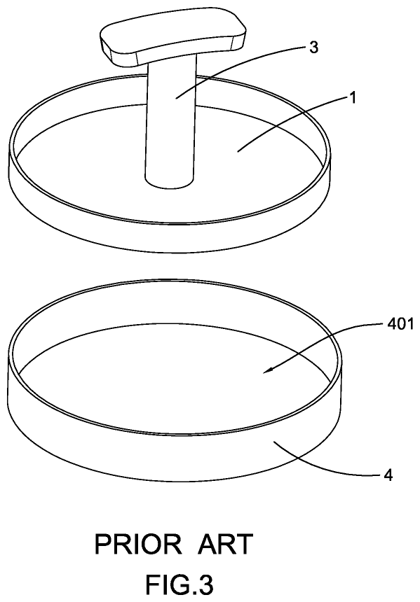

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

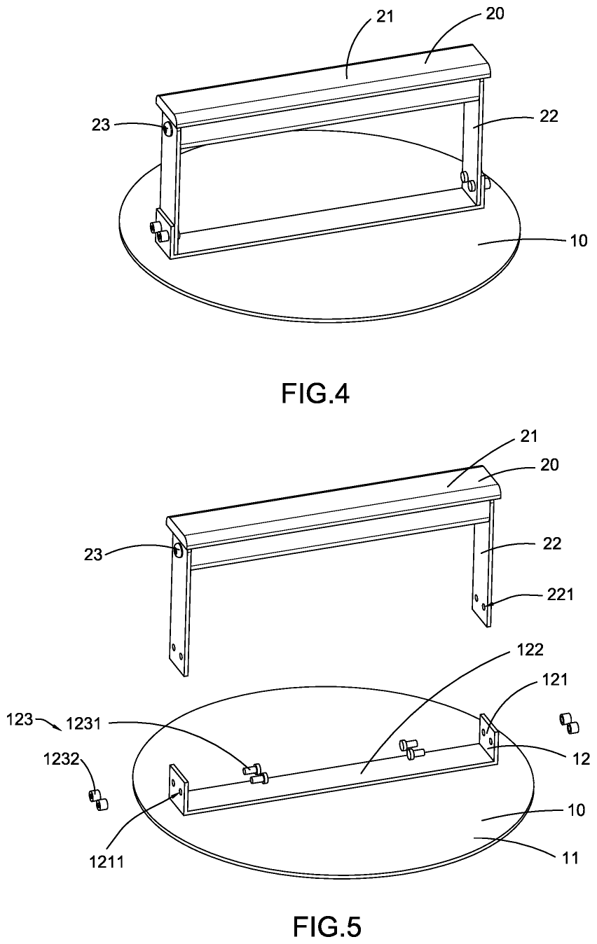

Referring to FIG. 4 to FIG. 7 of the drawings, a burger press according to a first preferred embodiment of the present invention is illustrated, the burger press comprises a pressing plate 10 and a handle frame 20 detachably mounted to the pressing plate 10. During transportation, the handle frame 20 can be detached from the pressing plate 10, so that the handle frame 20 and the pressing plate 10 can be independent from each other before usage, so as to reduce a storing room for the burger press.

More specifically, a burger press manufacturer may package a plurality of the pressing plates 10 which are overlapped and stacked with each other in a pressing plate storing box, and package a plurality of the handle frames 20 which are overlapped and stacked with each other in a handle frame storing box, so that it is convenient for the burger press manufacturer to ship and transport the burger presses from the factory to the warehouse or the retail store, and thus the storing and shipping cost is reduced.

When a burger presses distributor wants to ship the burger presses from the warehouse or the retail store to the end user, since the handle frame 20 can be detached from the pressing plate 10, and then the two separated components can be placed in a packaging box, the volume of the packaging box is reduced, fewer or no buffering and cushioning material is required to provide a cushioning effect to the two components during transportation. Since the handle frame 20 is not vertically extended from the pressing plate 10 during transportation, the risk of damage to the handle frame 20 can also be reduced.

According to this preferred embodiment, the pressing plate 10 of the burger press comprises a pressing body 11 and a mounting element 12 which is fixed and connected to a top of the pressing body 11 for detachably mounting the handle frame 20. The mounting element 12 is mounted to the pressing body 11 or integrally formed with the pressing body 11.

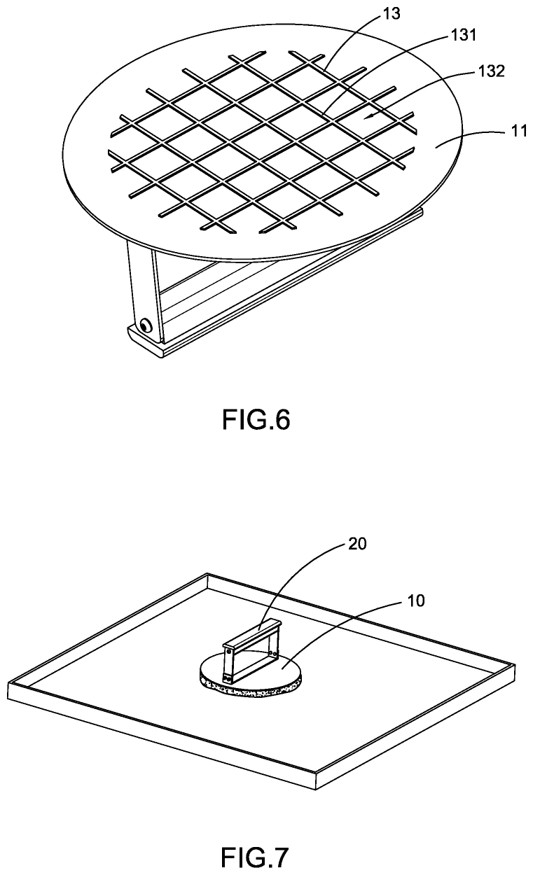

As shown in FIG. 6 of the drawings, the pressing plate 10 of the burger press comprises a smashing pattern 13 formed at a bottom of the pressing body 11 for forming a smashed pattern on a meat which is pressed under the pressing body 11. The smashing pattern 13 in this embodiment may comprise a plurality of smashing ribs 131 which are intersected with each other and protruded from a bottom of the pressing body 11 to define a plurality of grooves 132, so that when the meat is pressed and smashed under the pressing body 111, the meat is processed by the smashing pattern 13 to form a flat and grooved burger patty for the professional burger look.

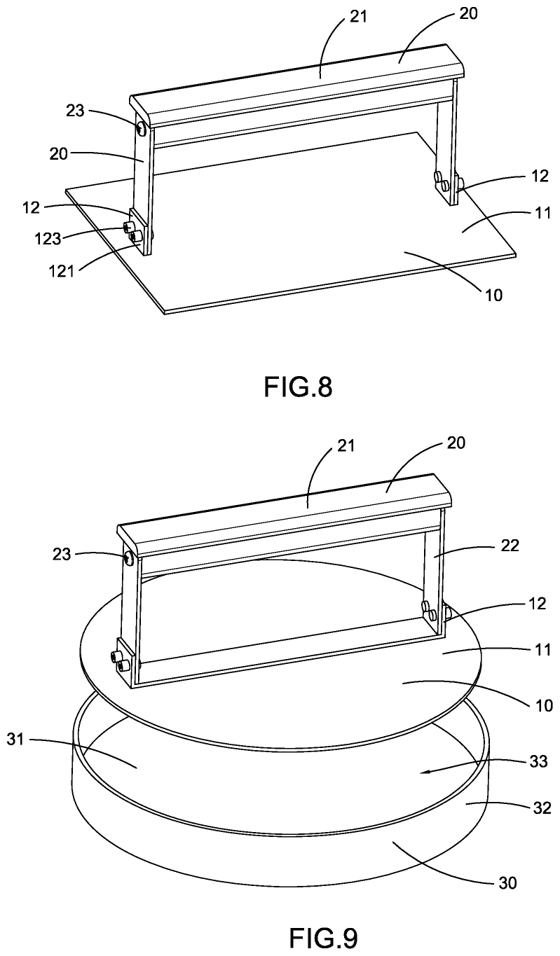

More specifically, the mounting element 12 comprises two mounting arms 121 provided above the pressing body 11 and a fixing piece 122 extended between the two mounting arms 121. The fixing piece 122, which is extended in a horizontal direction and is parallel with the top surface of the pressing body 11, is attached to or integrally formed with the top of the pressing body 11. The two mounting arms 121 are vertical mounting arms upwardly extended from the two ends of the fixing piece 122, as shown in FIG. 5 of the drawings. Alternatively, the two mounting arms 121 may be upwardly extended from the top of the pressing body 11, as shown in FIG. 8 of the drawings. Accordingly, the two mounting arms 121, which are extended in vertical directions, are vertically or inclinedly extended from the fixing piece 122 or the top of the pressing body 11 for mounting the handle frame 20.

The handle frame 20 comprises an operation handle 21 and two connector arms 22 connected to two ends of the operation handle 21. Accordingly, the operation handle 21, which is arranged to a user's hand to hold thereon, may be mounted and assembled to the two connector arms 22, or may be integrally formed with the two connector arms 22. As shown in FIG. 4 and FIG. 5 of the drawings, each of the two ends of the operation handle 21 are respectively mounted to the two connector arms 22 by a fixing element 23 which may be a rivet, or a bolt nut connector.

The handle frame 20 is detachably mounted to the two mounting arms 121 of the mounting element 12. More specifically, the two connector arms 22 are respectively mounted to the two mounting arms 121 of the mounting element 12, so as to detachably mount the handle frame 20 with the pressing plate 10.

As shown in FIG. 4 and FIG. 5 of the drawings, each mounting arm 121 of the mounting element 12 has one or more mounting holes 1211, while each corresponding connector arm 22 has one or more connecting holes 221 which are respectively adapted for being aligned with the mounting holes 1211. The mounting element 12 further comprises a plurality of connecting members 123 for engaging with the mounting holes 1211 of each mounting arm 121 and connecting holes 221 of each connector arm 22 to detachably mount each connector arm 22 with the corresponding mounting arm 121.

Each of the connecting members 123 may be embodied as a bolt-nut connector which comprises a bolt 1231 and a screw nut 1232, the bolt 1232 can be penetrated through the corresponding mounting hole 1211 of the mounting arm 121 and connecting hole 221 of the connector arm 22, so as to be engaged with the screw nut 1232, so as to mount each connector arm 22 with the corresponding mounting arm 121. As shown in FIG. 5 of the drawings, the mounting element 12 comprises four connecting members 123 for detachably mounting the two connector arms 22 to the two mounting arms 121 of the mounting element 12, so as to detachably mount the handle frame 20 with the pressing plate 10. According to this embodiment, the two connector arms 22 can be assembled at inner sides of the two mounting arms 121 of the mounting element 12 by the connecting members 123 which are horizontally penetrated through the two connector arms 22 and the two mounting arms 121 of the mounting element 12.

The pressing body 11 of the pressing plate 10 of this embodiment can be configured to have a desired shape. For example, the pressing body 11 can be a round plate that is adapted for pressing and smashing the meat into a round and disk-like patty. The fixing piece 122 is extended along a diameter of the round pressing body 11, and the handle frame 10 is provided at a position above a central area of the pressing plate 10 for a user to hold on the operation handle 21 to apply a pressing force to drive the pressing plate 10 to move downward to evenly press and smash the meat.

Accordingly, before the burger press is delivered to the user, the two connector arms 22 are not assembled on the two mounting arms 121 of the mounting element 12, so that the handle frame 20 is detached from the pressing plate 10, so that the burger press is convenient for storing and transportation. When the burger press is shipped to the user by the burger press distributor, the user is only required to use the connecting members 123 to mount and assemble the two connector arms 22 of the handle frame 20 with the two mounting arms 121 of the mounting element 12, so that the assembling process is easy and not effort costing.

The pressing plate 10 and the handle frame 20 can be made of any suitable material. For example, the pressing plate 10 and the handle frame 20 can be made of plastic, metal, metal alloy, ceramic and wood. As a specific example, the pressing plate 10 and and the handle frame 20 may be made of metal to form a heavy duty steak and burger press. Alternatively, the operation handle 21 of the handle frame 20 can be made of wood for a user to hold on while the connector arms 22 of the handle frame 20 are made of metal, so that the heat on the connector arms 22 is not easy to be transferred to the wooden operation handle 21 to hurt the user's holding hand.

As shown in FIG. 7 of the drawings, when the user has assembled the pressing plate 10 with the handle frame 20, the user can hold on the operation handle 21 of the pressing plate 10 to direct the pressing body 11 of the pressing plate 10 to press the meat on a grill.

Accordingly, this embodiment of the present invention provides a method for transporting the burger press, in the transporting method, the pressing plate 10 and the handle frame 20 are separated from each other for transportation. The handle frame 20 can be horizontally stacked on the pressing plate 10, and then the two components can be packaged in a packaging box. Alternatively, during transportation, the pressing plate 10 and the handle frame 20 can be stored in different packaging boxes or packaging bags.

Referring to FIG. 8 of the drawings, a burger press according to a first alternative mode of the above first preferred embodiment of the present invention is illustrated. In this embodiment, the two mounting arms 121 of the mounting element 12 are vertically extended from the pressing body 11 of the pressing frame, and the two connector arms 22 of the handle frame 20 can be detachably mounted to the two mounting arms 121 of the mounting element 12 in an end to end manner. No fixing piece 122 is required in this embodiment.

Referring to FIG. 9 of the drawings, a burger press according to a second alternative mode of the above first preferred embodiment of the present invention is illustrated. In this embodiment, the burger press comprises the pressing plate 10, the handle frame 20 and a receiving base 30 which comprises a bottom wall 31 and a surrounding wall 32 vertically extended from the bottom wall 31 to define a pressing chamber 33 within the bottom wall and the surrounding wall 32.

Accordingly, in this embodiment, the burger press comprises an additional accommodating container for receiving and shaping the meat within the pressing chamber 33. The pressing plate 10 and the handle frame 20 can be configured with the same structures mentioned and disclosed above so that the burger press is easy for transportation.

During usage, the meat to be pressed is put into the pressing chamber 33 of the receiving base 30, and then the user may hold on the operation handle 21 to drive the pressing body 11 of the pressing plate 10 to be fitted into the pressing chamber 33 of the receiving base 30 for pressing and shaping the meat in the pressing chamber 33 of the receiving base 30. Alternatively, a parchment paper may be put into the pressing chamber 33 of the receiving base 30 on the bottom wall 31 of the receiving base 30 before placing the meat to be pressed and smashed, so that after the pressing and smashing process, the patty processed from the meat is easy to be take out of the pressing chamber 33 of the receiving base 30.

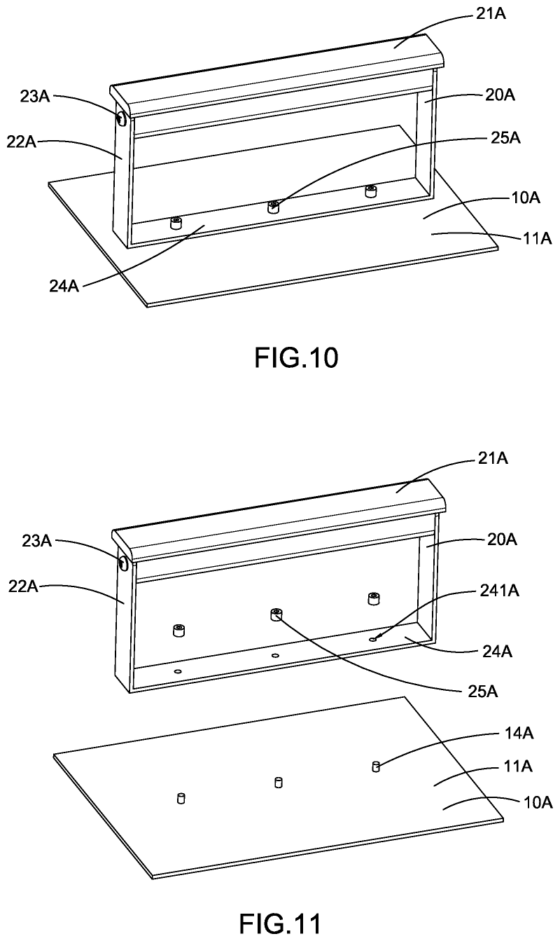

Referring to FIG. 10 to FIG. 11 Of the drawings, a burger press according to a second preferred embodiment of the present invention is illustrated. The burger press comprises a pressing plate 10A and a handle frame 20A which can be detachably mounted to the pressing plate 10A, so that the pressing plate 10A and the handle frame 20A can be detached from each other for easy transportation.

The pressing plate 10A comprises a pressing body 11A and one or more bolts 14A protruded from a top of the pressing body 11A. The handle frame 20A comprises an operation handle 21A, one or more, such as two, connector arms 22A extended from the operation handle 21A, and a bottom attaching piece 24A which can be detachably mounted to the pressing plate 10A.

The bottom attaching piece 24A has one or more assembling holes 241A to align with the bolts 14A on the pressing body 11A, the handle frame 20A further comprises one or more screw nuts 25A which are respectively engaged with the bolts 14A so as to detachably mount the handle frame 20A with the pressing plate 10A.

In other words, in this embodiment, the bottom attaching piece 24A which can be stacked and attached on the top surface of the pressing body 11A and is extended along a central line of the pressing body 11A, rather than the two connector arms 22A, is used for detachably assembling the handle frame 20A to the pressing plate 10A.

Similarly, the operation handle 21A, which is arranged to a user's hand to hold thereon, may be mounted and assembled to the two connector arms 22A, or may be integrally formed with the two connector arms 22A. As shown in FIG. 11 of the drawings, each of the two ends of the operation handle 21A are respectively mounted to the two connector arms 22A by a fixing element 23A which may be a rivet, or a bolt nut connector. The operation handle 21A and the connector arms 22A may be made of same material, or may be made of different materials. For example, the operation handle 21A is made of wood while the connector arms 22A are made of metal.

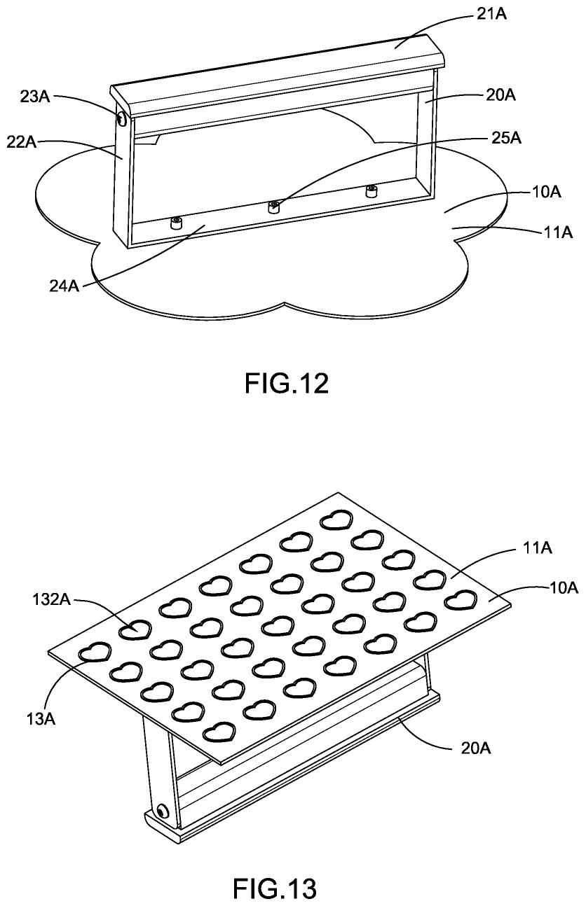

It is worth mentioning that the shape of the pressing body 11A is not limited. As shown in FIG. 11 of the drawings, the pressing body 11A is configured to be a rectangular plate. As shown in FIG. 12 of the drawings, the pressing body 11A may be configured to be other shapes such as star-like shape.

In addition, since the pressing plate 10A is detachably mounted with the handle frame 20A. The burger press may be provided with a plurality of pressing plates 10A along with the handle frame 20A. The plurality of pressing plates 10A can be configured with different smashing patterns 13A so that the user is able to select one pressing plate 10A from the plurality of pressing plates 10A for processing and pressing the meat to obtain a desired pattern on the meat.

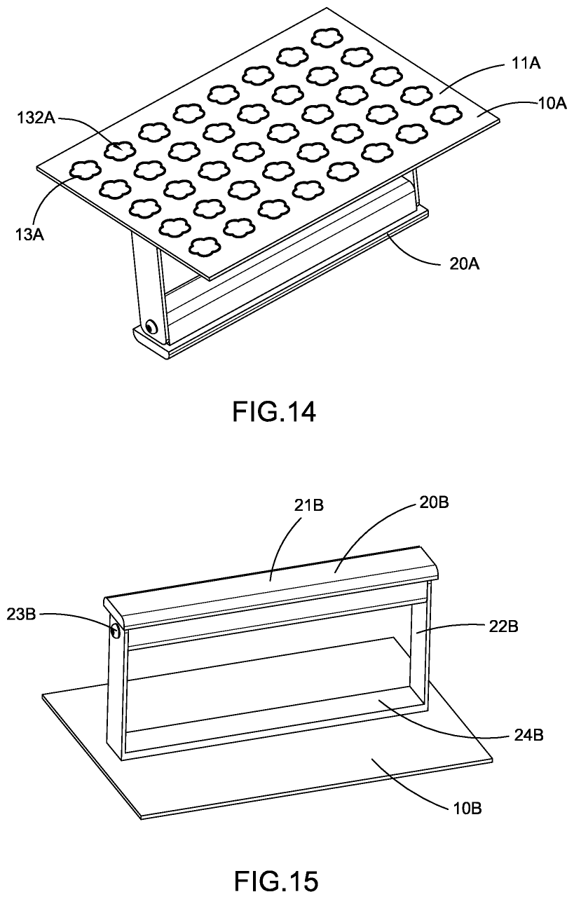

As shown in FIG. 13 of the drawings, one of the pressing plate 10A may be arranged with a plurality of grooves 132A which have heart-like shapes. As shown in FIG. 14 of the drawings, another pressing plate 10A may be arranged with a plurality of grooves 132A which have star-like shapes.

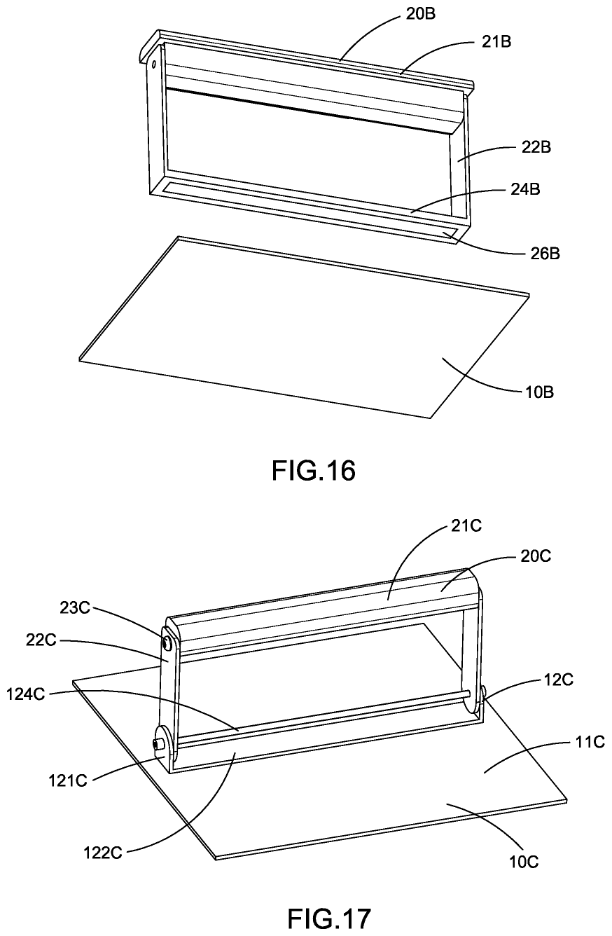

Referring to FIG. 15 and FIG. 16 of the drawings, a burger press according to a third preferred embodiment of the present invention is illustrated. The burger press comprises a pressing plate 10B and a handle frame 20B. The pressing plate 10B comprises a pressing body 11. The handle frame 20B comprises an operation handle 21B, one or more, such as two, connector arms 22B extended from the operation handle 21B, and a bottom attaching piece 24B which can be detachably mounted to the pressing plate 10B.

In this embodiment, the bottom attaching piece 24B can be magnetically attracted to the pressing body 11B of the pressing plate 10B, so that the handle frame 20B can be detachably mounted with the pressing plate 10B. For example, the bottom attaching piece 24B is provided with a magnet 26B at a bottom surface thereof for magnetically attracting with the pressing body 11B which is made of a magnetically attracting material. Alternatively, the bottom attaching piece 24B of the handle frame 20B is provided with a first magnetically attracting element, and the pressing body 11B of the pressing plate 10B is provided with a second magnetically attracting element, and the first magnetically attracting element is able to magnetically attracted with the second magnetically attracting element, so as to detachably mount the handle frame 20B with the pressing plate 10B.

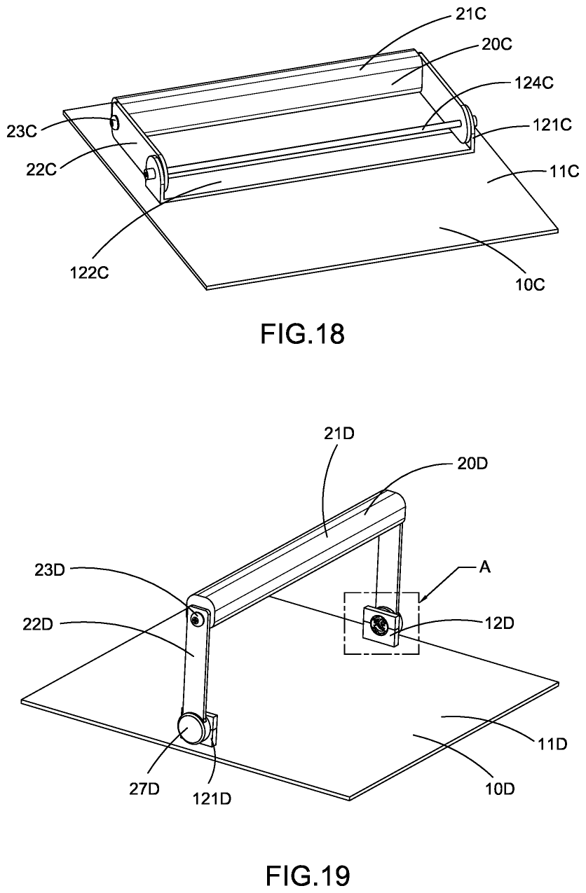

Referring to FIG. 17 to FIG. 18 of the drawings, a burger press according to a fourth preferred embodiment of the present invention is illustrated. The burger press comprises a pressing plate 10C and a handle frame 20C which is pivotally mounted to the pressing plate 10C and is able to be moved between an unfolded state for the user to press the meat and a folded state for facilitating the storing and transportation of the burger press.

More specifically, when in the unfolded state, the handle frame 20C is vertically extended from the pressing plate 10C for the user to hold on. When in the folded state, the handle frame 20C is folded towards the pressing plate 10C, so as to be substantially parallel with the pressing plate 10C. In other words, the handle frame 20C is stacked on the pressing plate 10C when the burger press is in the folded state, so that the height of the burger press in the folded state is reduced, and thus the burger press in the folded state is suitable for being transported.

The pressing plate 10C of the burger press comprises a pressing body 11C and a mounting element 12C which is fixed and connected to a top of the pressing body 11C for pivotally mounting the handle frame 20C. The mounting element 12C is mounted to the pressing body 11C or integrally formed with the pressing body 11C.

More specifically, the mounting element 12C comprises two mounting arms 121C provided above the pressing body 11C and a fixing piece 122C extended between the two mounting arms 121C. The fixing piece 122C, which is extended in a horizontal direction and is parallel with the top surface of the pressing body 11C, is attached to or integrally formed with the top of the pressing body 11C. The two mounting arms 121C are vertical mounting arms upwardly extended from the two ends of the fixing piece 122C, as shown in FIGS. 17 and 18 of the drawings. Alternatively, the two mounting arms 121C may be upwardly extended from the top of the pressing body 11C. Accordingly, the two mounting arms 121C, which are extended in vertical directions, are vertically or inclinedly extended from the fixing piece 122C or the top of the pressing body 11C for mounting the handle frame 20C.

The handle frame 20C comprises an operation handle 21C and two connector arms 22C connected to two ends of the operation handle 21C. Accordingly, the operation handle 21C, which is arranged to a user's hand to hold thereon, may be mounted and assembled to the two connector arms 22C, or may be integrally formed with the two connector arms 22C. As shown in FIG. 18 of the drawings, each of the two ends of the operation handle 21C are respectively mounted to the two connector arms 22C by a fixing element 23C.

The handle frame 20C is pivotally mounted to the two mounting arms 121C of the mounting element 12C. More specifically, the two connector arms 22C are respectively pivotally mounted to the two mounting arms 121C of the mounting element 12C, so as to pivotally mount the handle frame 20C with the pressing plate 10C.

As shown in FIG. 18 of the drawings, the mounting element 12C further comprises a connecting pin 124C for pivotally mounting the two connector arms 22C with the two mounting arms 121C. In other words, the connecting pin 124C is penetrated through the ends of the connector arm 22C and the mounting arm 121C to allow the corresponding connector arm 22C to be pivotally movable with respect to the mounting ram 121C.

Referring to FIG. 19 to FIG. 21 of the drawings, a burger press according to a fifth preferred embodiment of the present invention is illustrated. The burger press comprises a pressing plate 10D and a handle frame 20D which is pivotally mounted to the pressing plate 10D and is able to be moved between an unfolded state for the user to press the meat and a folded state for facilitating the storing and transportation of the burger press.

More specifically, when in the unfolded state, the handle frame 20D is vertically extended from the pressing plate 10D for the user to hold on. When in the folded state, the handle frame 20D is folded towards the pressing plate 10D, so as to be substantially parallel with the pressing plate 10D.

The pressing plate 10D of the burger press comprises a pressing body 11D and a mounting element 12D which is fixed and connected to a top of the pressing body 11D for pivotally mounting the handle frame 20D. The mounting element 12D is mounted to the pressing body 11D or integrally formed with the pressing body 11D.

More specifically, the mounting element 12D comprises two mounting arms 121D provided above the pressing body 11D. The two mounting arms 121D are vertical mounting arms upwardly extended from the top of the pressing body 11D.

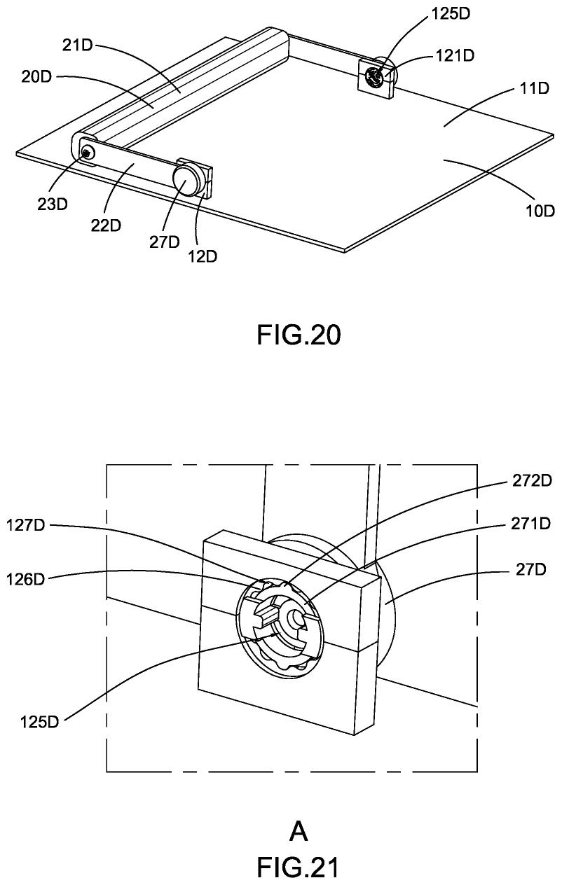

The handle frame 20D comprises an operation handle 21D and two connector arms 22D connected to two ends of the operation handle 21D. Accordingly, the operation handle 21D, which is arranged to a user's hand to hold thereon, may be mounted and assembled to the two connector arms 22D, or may be integrally formed with the two connector arms 22D. As shown in FIG. 20 of the drawings, each of the two ends of the operation handle 21D are respectively mounted to the two connector arms 22D by a fixing element 23D.

The handle frame 20D is pivotally mounted to the two mounting arms 121D of the mounting element 12D. More specifically, the two connector arms 22D are respectively pivotally mounted to the two mounting arms 121D of the mounting element 12D, so as to pivotally mount the handle frame 20D with the pressing plate 10D.

As shown in FIG. 21 of the drawings, each of the two mounting arms 121D has a engaging hole 125D penetrating a thickness thereof, a plurality of engaging teeth 126D are provided around the engaging hole 126D and defining a plurality of engaging grooves 127D between two adjacent engaging teeth 126D.

The handle frame 20D further comprises two connector heads 27D which are respectively engaged with the two mounting arms 121D in such a manner that the two connector arms 22D are able to pivotally rotate with respect to the two mounting arms 121D respectively.

As shown in FIG. 21 of the drawings, each connector head 27D comprises an engaging portion 271D fitted into the engaging hole 125D and comprises two retaining teeth 272D at two opposite sides of the engaging portion 271D for being positioned and retained in the corresponding engaging grooves 127D to retain the corresponding connector arm 22D in position after rotation.

In other words, when the connector arms 22D are rotated with respect to the mounting arms 121D so as to be stacked on the pressing plate 10D, the burger press is in the folded state so that the burger press is easy for transportation. When the connector arms 22D are rotated with respect to the mounting arms 121D to be moved to a position that is vertical to the pressing plate, the burger press is moved into the unfolded state that is ready for using. The engagement between the engaging portion 271D of each connector arm 22D with the engaging hole 125D in the corresponding mounting arm 121D enables the rotational movement of each connector arm 22D.

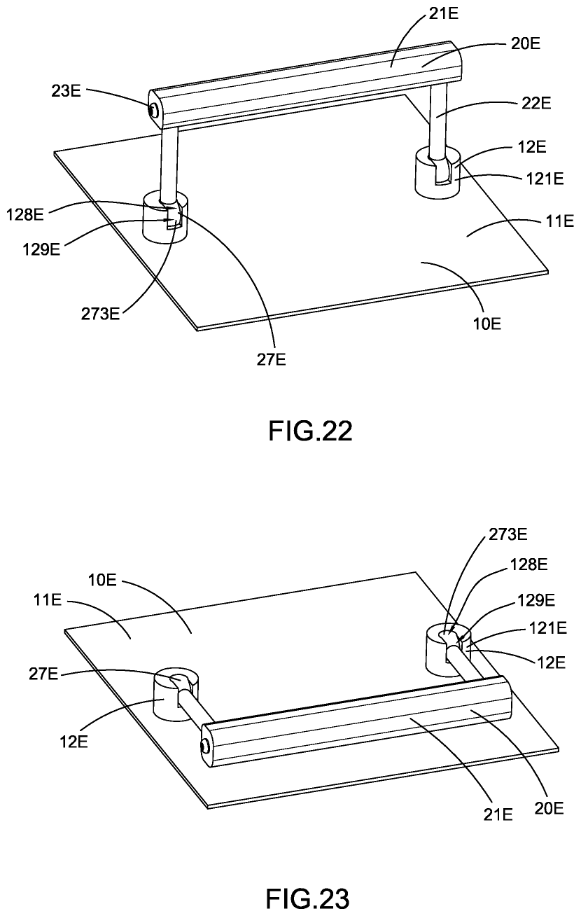

Referring to FIG. 22 to FIG. 23 of the drawings, a burger press according to a sixth preferred embodiment of the present invention is illustrated. The burger press comprises a pressing plate 10E and a handle frame 20E which is pivotally mounted to the pressing plate 10E and is able to be moved between an unfolded state for the user to press the meat and a folded state for facilitating the storing and transportation of the burger press.

More specifically, when in the unfolded state, the handle frame 20E is vertically extended from the pressing plate 10E for the user to hold on. When in the folded state, the handle frame 20E is folded towards the pressing plate 10E, so as to be substantially parallel with the pressing plate 10E.

The pressing plate 10E of the burger press comprises a pressing body 11E and a mounting element 12E which is fixed and connected to a top of the pressing body 11E for pivotally mounting the handle frame 20E. The mounting element 12E is mounted to the pressing body 11E or integrally formed with the pressing body 11E.

More specifically, the mounting element 12E comprises two mounting arms 121D provided above the pressing body 11E. The two mounting arms 121E are vertical mounting arms upwardly extended from the top of the pressing body 11E.

The handle frame 20E comprises an operation handle 21E and two connector arms 22E connected to two ends of the operation handle 21E. Accordingly, the operation handle 21E, which is arranged to a user's hand to hold thereon, may be mounted and assembled to the two connector arms 22E, or may be integrally formed with the two connector arms 22E. Each of the two ends of the operation handle 21E are respectively mounted to the two connector arms 22E by a fixing element 23E.

The handle frame 20E is pivotally mounted to the two mounting arms 121E of the mounting element 12E. More specifically, the two connector arms 22E are respectively pivotally mounted to the two mounting arms 121E of the mounting element 12E, so as to pivotally mount the handle frame 20E with the pressing plate 10E.

As shown in FIGS. 22 and 23 of the drawings, each of the two mounting arms 121E has a rotation chamber 128E and a slot 129E communicated to the rotation chamber 128E. The handle frame 20E further comprises two connector heads 27E which are respectively engaged with the two mounting arms 121E in such a manner that the two connector arms 22E are able to pivotally rotate with respect to the two mounting arms 121E respectively.

More specifically, as shown in FIGS. 22 and 23 of the drawings, each connector head 27E comprises a rotating ball 273E fitted into the rotation chamber 128E of the corresponding mounting arm 121E so as to allow the rotational movement of each connector arm 22E while the rotation path of each connector arm 22E is restricted by the slot 129E.

Similarly, when the connector arms 22E are rotated with respect to the mounting arms 121E so as to be stacked on the pressing plate 10E, the burger press is in the folded state so that the burger press is easy for transportation. When the connector arms 22E are rotated with respect to the mounting arms 121E to be moved to a position that is vertical to the pressing plate, the burger press is moved into the unfolded state that is ready for using. The engagement between the rotating ball 273E of each connector arm 22E with the rotation chamber 128E and slot 129E in the corresponding mounting arm 121E enables the rotational movement of each connector arm 22E.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention includes all modifications encompassed within the spirit and scope of the following claims.

What is claimed is:

1. A burger press, comprising:
a pressing plate; and
a handle frame, wherein said handle frame is configured for being detachably mounted to said pressing plate, wherein said handle frame and said pressing plate are detached from each other for transportation.

2. The burger press according to claim 1, wherein said pressing plate comprises a pressing body comprising a smashing pattern at a bottom thereof and a mounting element, wherein said handle frame comprises an operation handle and one or more connector arms, wherein said one or more connector arms are configured for being detachably mounted to said mounting element.

3. The burger press according to claim 2, wherein said pressing plate comprises said mounting element comprises two mounting arms provided above said pressing body, wherein said handle frame comprises two said connector arms extended from said operation handle, wherein said two connector arms are configured for being respectively detachably mounted to said two mounting arms.

4. The burger press according to claim 3, wherein said two mounting arms are integrally protruded from said pressing body of said pressing plate.

5. The burger press according to claim 3, wherein said mounting element comprises a fixing piece which is attached on said pressing body, wherein said two mounting arms are integrally protruded from two ends of said fixing piece.

6. The burger press according to claim 1, wherein said handle frame comprises an operation handle and a bottom attachment piece, wherein said operation handle and said bottom attachment piece are provided at opposite sides of aid handle frame, wherein said bottom attachment piece is arranged for being detachably mounted to the pressing plate.

7. The burger press according to claim 6, wherein said handle frame comprises two connector arms extended from two ends of said operation handle, said bottom attachment piece is extended between said two connector arms and are configured for being detachably mounted to said pressing plate by one or more bolt-nut connectors.

8. The burger press according to claim 1, wherein said burger press comprises a plurality of said pressing plates for detachably coupling with the same handle frame, wherein said plurality of pressing plates comprise different smashing patterns.

9. The burger press according to claim 1, wherein said burger press comprises a receiving base which comprise a bottom wall and a surrounding wall extended from said bottom wall to define a receiving chamber to allow said pressing plate to be fitted into said receiving chamber to achieve pressing operation.

10. The burger press according to claim 1, wherein said pressing plate and said handle frame are configured to be magnetically attracted with each other.

11. The burger press according to claim 1, wherein said pressing plate and said handle frame are made the material selected from the group consisting of plastic, metal, metal alloy, ceramic and wood.

12. The burger press according to claim 1, wherein said pressing plate and said handle frame are made the material selected from the group consisting of plastic, metal, metal alloy, ceramic and wood.

13. The burger press according to claim 2, wherein said smashing pattern has a plurality of grooves.

14. A burger press, comprising:
a pressing plate; and
a handle frame, wherein said handle frame is movably mounted to said pressing plate and is moved between a folded state in which said handle frame is folded and stacked on said pressing plate for transportation and an unfolded state in which said handle frame is unfolded for a user to operate.

15. The burger press according to claim 14, wherein when in said folded state, said pressing plate is parallel with said pressing plate, wherein when in said unfolded state, said handle frame is vertically extended from said pressing plate.

16. The burger press according to claim 14, wherein said handle frame is pivotally mounted to said pressing plate.

17. The burger press according to claim 14, wherein said handle frame comprises an operation handle and at least one connector arm extended from said operation handle, wherein said pressing plate comprises a pressing body and a mounting element at a top of said pressing body, wherein said connector arm of said handle frame is pivotally mounted to said mounting element.

18. The burger press according to claim 17, wherein said mounting element comprises two mounting arms and a connecting pin penetrating through said two mounting arms, wherein said handle frame comprises two said connector arms which are pivotally mounted to said connecting pin, wherein said operation handle is extended between two said connector arms.

19. The burger press according to claim 17, wherein said mounting element comprises two mounting arms each having an engaging hole, wherein said handle frame comprises two said connector arms each comprising a connector head, wherein a plurality of engaging teeth are provided around said engaging hole and defining a plurality of engaging grooves between two adjacent engaging teeth, wherein each connector head comprises an engaging portion fitted into said engaging hole and comprises at least one retaining tooth for being positioned and retained in the corresponding engaging groove to retain said corresponding connector arm in position after rotation.

20. The burger press according to claim 17, wherein said mounting element comprises two mounting arms each having a rotation chamber and a slot communicated to said rotation chamber, wherein said handle frame comprises two said connector arms each comprising a connector head, wherein said connector head comprises a rotating ball which is rotably disposed in said rotation chamber to direct said connector arm to rotate at said slot.
